(19) United States
(12) Patent Application Publication
(10) Pub. No.: US 2010/0260010 A1
(43) Pub. Date: Oct. 14, 2010

(54) CONTAINER WITH FLEXIBLE WALLS

(75) Inventor: Maik Jornitz, Manorville, NY (US)

Correspondence Address: HESPOS & PORCO LLP, 110 West 40th Street, Suite 2501, NEW YORK, NY, 10018, US

(73) Assignee: SARTORIUS STEDIM BIOTECH GMBH, Goettingen (DE)

(21) Appl. No.: 12/745,706

(22) PCT Filed: Dec. 12, 2008
(86) PCT No.: PCT/EP08/10565

§ 371 Date: Jun. 2, 2010

(30) Foreign Application Priority Data
Dec. 18, 2007 (DE) 10 2007 061 664.5

(51) Int. Cl. B01F 13/00; B65D 37/00

(52) U.S. Cl. 366/343; 222/211

(57) ABSTRACT

A container with a flexible container wall, in particular a disposable bioreactor, with a container interior in which a a mixer is arranged at one end of a mixer shaft which is passed through the container wall and is drivable from the outside, wherein the mixer shaft and/or mixer is/are designed such that it/they are foldable and such that it/they can be stabilized from the outside.

### BACKGROUND OF THE INVENTION

1. Field of the Invention

The invention relates to a container with a flexible container wall, in particular a bioreactor or a mixer bag, with a container interior in which a mixer is arranged, the mixer shaft of which is passed at at least one end through the container wall and is driven from the outside.

2. Description of the Related Art

Containers with a flexible wall are increasingly used in particular as flexible disposable containers or mixing bags in the pharmaceutical/biotechnology industry where, in a very wide variety of applications, sterile liquids not only have to be decanted, transported and stored but also mixed.

DE 10 2006 020 813 B3 discloses a disposable bioreactor which is designed as a flexible bag or container. The interior of the flexible container has a mixer, the mixer shaft of which is guided rotatably as an axis of rotation in a bearing arranged in the container wall and is driven by a motor arranged outside the flexible container. In this case, the flexible container is stabilized by a supporting container at least for the mixing.

A drawback of the known flexible container, which has basically proven worthwhile, is that the rigid stirring mechanism thereof or mixer takes up a relatively large amount of space in the empty container and therefore takes up a considerable size when packaged. In addition, in some flexible containers available on the market, the mixer which is connected to the rigid shaft may result in undesirable rubbing in association with defects on the inner wall of the container.

WO 03/012027 A1 furthermore discloses a bioreactor with flexible walls. In this case, the bioreactor is designed as an inflatable or unfoldable apparatus where a container wall surrounding the container interior can be stabilized by an inflatable structure. This known flexible container also has the abovementioned drawbacks.

U.S. Pat. No. 6,494,613 B2 describes a container with a flexible container wall and with a container interior in which a flexible tube which is passed at one end through the container wall is arranged as the mixer shaft. A shaped rod is introduced into the tube from the outside and is driven in a rotating manner in the tube whereas the tube is fixed in the container wall. Drawbacks include not only the low mixing power, which is realized only by means of the mixer shaft, but also the short service life because the high mechanical stresses caused during rotation of the rod mean that the tube rapidly becomes brittle in the region in which it is fastened to the container wall, which leads to contamination of the products being mixed or of the environment.

Therefore, it is the object of the present invention to improve known containers in such a manner that they can be collapsed in the empty state together with the mixer to form a size of packaging which is as small as possible, and can be operated with a high degree of safety.

### SUMMARY OF THE INVENTION

This object is achieved by a flexible container wall and a container interior in which a mixer is arranged at one end of a hollow mixer shaft that is passed through the container wall and is drivable from the outside. At least part of the mixer shaft projecting into the container interior is designed such that it is foldable and such that it can be stabilized by flowable media which can be introduced from the outside, and/or in that the mixer is designed such that it is hollow, is foldable and can be stabilized by flowable media which can be introduced from the outside. In this case, the cavities of the mixer shaft and of the mixer are connected in a communicating manner.

By means of the foldable design of the mixer shaft and/or of the mixer, the flexible container can be folded to form a relatively small size of pack. If the mixer is designed to be flat, for example in the form of a two-arm blade, the empty container can be correspondingly flat and folded at least once in the longitudinal direction of the shaft and stored in a space-saving manner. Upon use, the container is then unfolded, if appropriate placed into a supporting container, and filled via supply lines with the liquid media to be mixed. For the mixing, the mixer shaft is stabilized from the outside and the outer end thereof which faces away from the mixer is connected or coupled to the mixer drive.

In a preferred embodiment of the invention, the flowable media are gases or curable gels, polymer foams, pastes and resins. Prior to being put into operation, the media are placed in a flowable state, generally under pressure, into the hollow mixer shaft and/or hollow mixer. After curing of the gels, polymer foams, pastes and resins, the device is ready for operation. In the event of gases being introduced, the pressure in the mixer shaft and/or the mixer is set in such a manner that the stiffness of said gases is maintained as a function of the stirring speed and the viscosity of the product being mixed.

According to another preferred embodiment of the invention, the mixer shaft is designed to be inflatable and, for this purpose, has at least one stabilizing chamber which is inflatable from the outside and runs in the longitudinal direction thereof. In the empty, noninflated state, the container can be collapsed to form a small volume, as described, and stored in a space-saving manner. Upon use, the mixer shaft is then inflated by compressed air or another gas being supplied into the at least one stabilizing chamber thereof, for example via a pump, and being brought into the envisaged shape thereof. The container can then be filled via supply lines with the media to be mixed. In principle, as described above, the container may also be filled first and then the mixer shaft stabilized.

According to another preferred embodiment of the invention, the stabilizing chamber is arranged such that it runs helically in the mixer shaft toward the mixer. The stabilizing chamber is preferably coiled in the opposite direction to the direction of rotation of the mixer.

The helical arrangement of the stabilizing chamber considerably increases the stability of the foldable shaft. In this case, coiling counter to the direction of rotation of the shaft has furthermore proven favorable. It is also possible for two consecutively offset, coiled stabilizing chambers to be arranged in the longitudinal direction of the mixer shaft. It is also possible in principle to provide two stabilizing chambers which are arranged radially next to each other and are coiled in an opposed manner on the mixer shaft.

According to another preferred embodiment of the invention, the mixer shaft has at least one stabilizing channel which runs in the longitudinal direction thereof, is fittable from the outside and into which a stabilizing rod can be introduced. In this case, the stabilizing rod can be designed as a relatively rigid metal wire which can be inserted into the stabilizing channel from the outside. The stabilizing channel or the stabilizing channels can be arranged on the mixer shaft both in addition to or instead of the stabilizing chambers.

The stabilizing channels may also be arranged in a coiled manner to increase the stability.

According to another preferred embodiment of the invention, the mixer shaft has, parallel to the longitudinal axis thereof, at least two mutually opposite, parallel guide channels in which two flexible tension wires are guided, said tension wires being fastened by the ends thereof facing the mixer in the region of the mixer-side end of the mixer shaft and the ends thereof which face away from the mixer projecting on the outside out of the mixer and being guided in a sliding manner in the guide channels and being braceable at the drive-side mixer shaft end in order to stabilize the mixer shaft.

In this embodiment, the mixer shaft can be folded with the flexible tension wires released from the bracing position thereof. In order to bring the mixer shaft into the stabilized, extended shape thereof, the two tension wires merely have to be braced outside the container. If appropriate, two further tension wires which can be braced can be arranged offset by 90°. It is also additionally possible, for example, for an inflatable stabilizing chamber to be arranged centrally in the mixer shaft.

According to another preferred embodiment of the invention, the stabilizing chamber is connected to a safety valve. The stabilizing chamber can therefore be reliably prevented from being able to be destroyed if inflated at too high a pressure.

According to another preferred embodiment of the invention, the mixer shaft is formed from a suitable plastic, preferably a polymer.

Further details of the invention emerge from the detailed description below and the attached drawings in which preferred embodiments of the invention are illustrated by way of example.

### BRIEF DESCRIPTION OF THE DRAWINGS

FIG. 1 shows a schematic side view of a container with flexible walls, a mixer and drive, partially in section.

FIG. 2 shows a side view of the container from FIG. 1 in section and outline in an enlarged illustration together with the inflatable mixer shaft.

FIG. 3 shows a side view of a mixer with a coiled stabilizing chamber in the mixer shaft in an enlarged illustration.

FIG. 4 shows a side view of a mixer with a stabilizing channel and stabilizing rod in the mixer shaft in an enlarged illustration.

FIG. 5 shows a side view of a mixer with two stabilizing channels and a central stabilizing chamber in the mixer shaft in an enlarged illustration.

FIG. 6 shows a side view of a mixer with two guide channels with tension wires and central stabilizing chamber in the mixer shaft in an enlarged illustration.

### DETAILED DESCRIPTION OF THE PREFERRED EMBODIMENT

A container 1 with a flexible container wall 2 essentially comprises a container interior 3 and a mixer 4.

The container 1 which is designed as a disposable bioreactor has the container interior 3, the flexible wall 2 of which, surrounding said container interior, comprises a lateral container wall 5, a container base 6 arranged at the bottom in the vertical direction and a container top 7 arranged at the top in the vertical direction. The mixer 4 is arranged at a lower end 8 of a mixer shaft 9 in the vertical direction. The upper end 10 of the mixer shaft 9 that faces away from the mixer 4 penetrates the container top 7 of the flexible container wall 2. The mixer shaft 9 which projects at the upper end 10 thereof out of the container 1 is connected at the upper end 10 thereof to a drive 11. The mixer shaft 9 is mounted in a sealed but rotatable manner in a bearing 12 of the flexible container wall 2 or, in the example, of the container top 7.

The mixer shaft 9 is formed from a flexible plastic and is foldable together with the flexible container wall 2 when the container interior 3 is empty. At the same time, the mixer shaft 9 is designed such that it can be stabilized in the unfolded interior 3 and when the latter is filled with liquid media 13 such that said mixer shaft, driven by the drive 11, sets the mixer 4 into a rotating mixing movement.

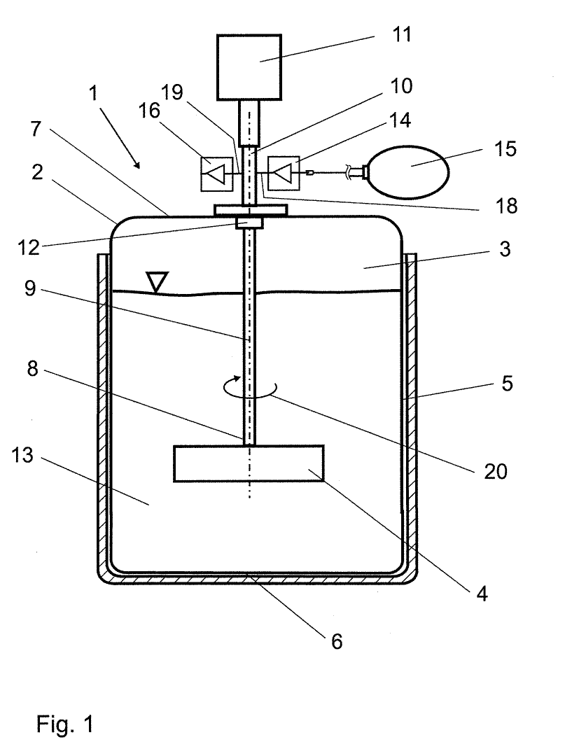

According to the exemplary embodiment of FIG. 1, the mixer shaft 9 is designed to be inflatable. For this purpose, the mixer shaft 9 can be supplied with compressed air from an attachable pressure line via a valve 14 or via an attachable pump 15. A safety valve 16 which is likewise arranged on the mixer shaft 9 operates as a pressure control valve and prevents the mixer shaft 9 from bursting as a consequence of an excess pressure.

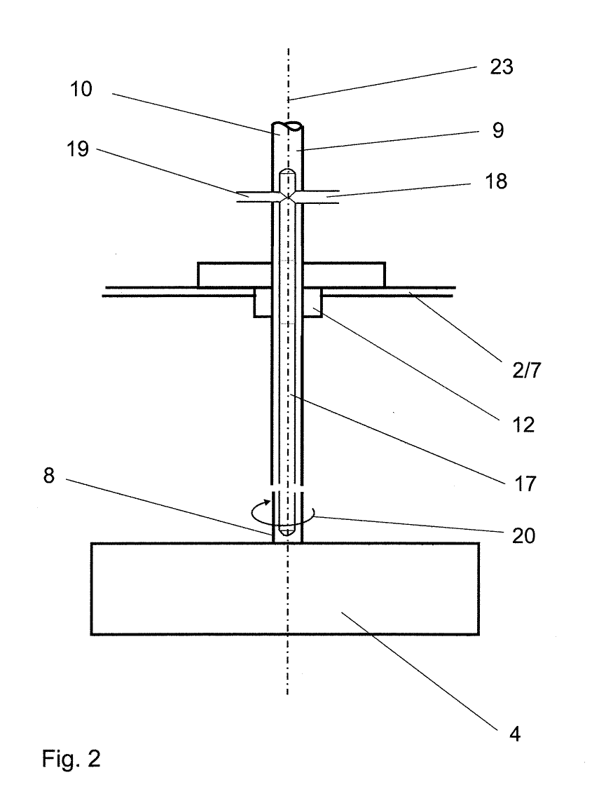

According to the exemplary embodiment of FIG. 2, the mixer shaft 9 has a stabilizing chamber 17 running centrally in the longitudinal direction thereof. The stabilizing chamber 17 is connected via a supply line 18 to the valve 14 and via a safety line 19 to the safety valve 16.

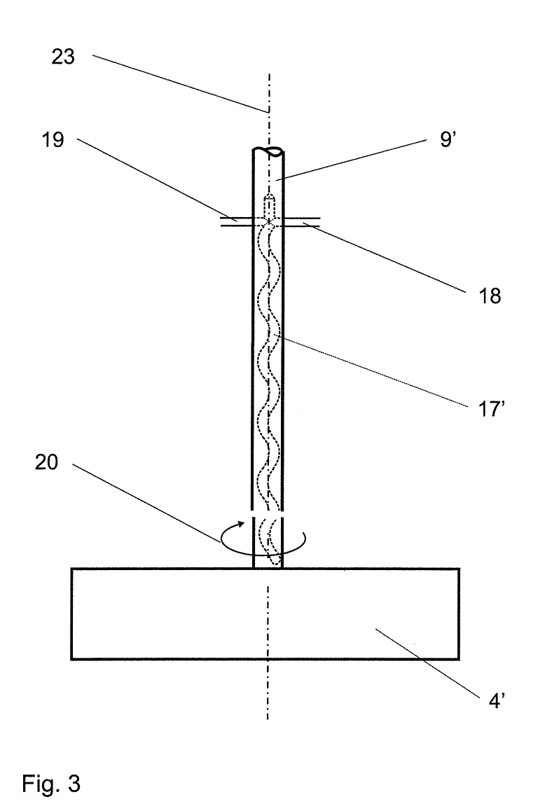

According to the exemplary embodiment of FIG. 3, the stabilizing chamber 17′ is arranged such that it runs helically in the mixer shaft 9′ toward the mixer 4′ in the opposite direction to the direction of rotation 20 of the mixer shaft 9′.

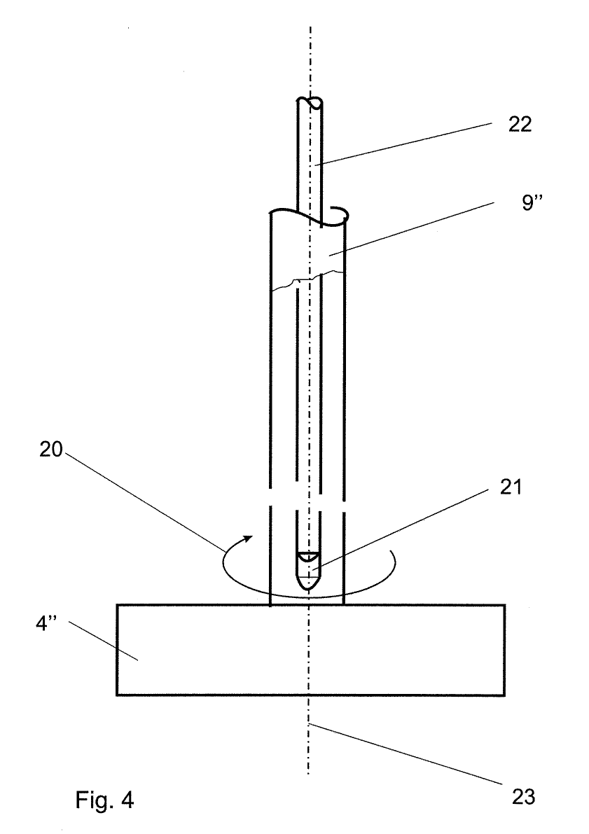

According to the exemplary embodiment of FIG. 4, the mixer shaft 9″ has a central stabilizing channel 21. A stabilizing rod 22 can be introduced in the stabilizing channel 21 for stabilization purposes.

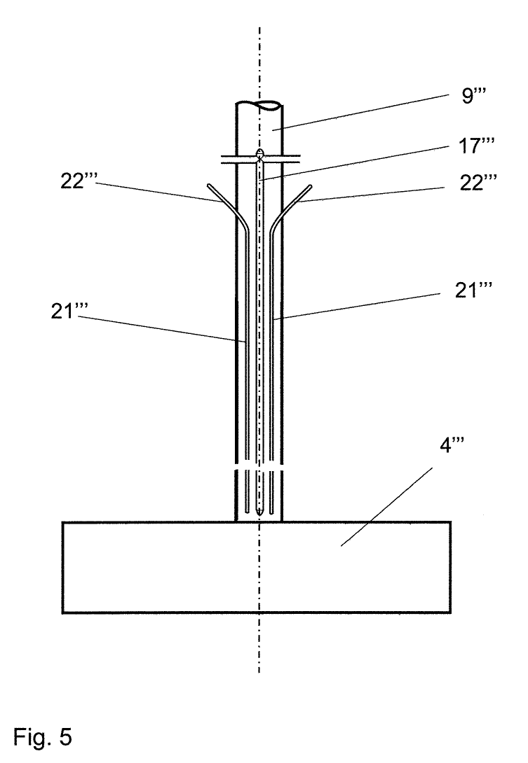

According to the exemplary embodiment of FIG. 5, the mixer shaft 9′″ has an inflatable stabilizing chamber 17′″ and, parallel to the stabilizing chamber 17′″, two mutually opposite stabilizing channels 21′″ into which the stabilizing rods 22′″ can be introduced for stabilizing purposes.

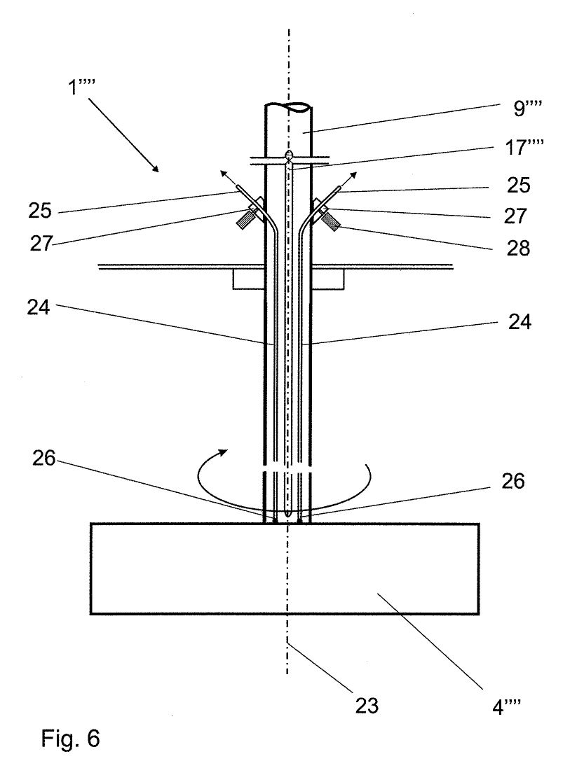

According to the exemplary embodiment of FIG. 6, the mixer shaft 9″″ likewise has an inflatable central stabilizing chamber 17″″. Parallel to the longitudinal axis 22 thereof, the mixer shaft 9″″ has two mutually opposite guide channels 24 in which two flexible tension wires 25 are guided. The flexible tension wires 25 are fixed at the ends 26 thereof which face the mixer 4″″, for example, to the mixer 4″. At the ends thereof which face away from the mixer 4″″, the flexible tension wires protrude laterally out of the mixer shaft 9″″ outside the container interior 3″″ of the container 1″″. In the unstable, empty state, the container 1″″ can be collapsed together with the mixer shaft 9″″ and the flexible tension wires 25. In order to stabilize the mixer shaft 9″″ the tension wires 25 can be fixed under tensile stress via fixing devices 27, which are arranged laterally on the mixer shaft 9″″, under tensile stress, for example by means of knurled screws 28.

1. A container (1, 1″″) comprising: a flexible container wall (2) defining a container interior (3, 3′″), a mixer (4, 4′, 4″″) arranged in the container interior (3, 3′″), a hollow mixer shaft (9, 9′, 9″, 9′″, 9″″) passed through the container wall (2) and having an inner end connected to the mixer (4, 4′, 4″″) so that the mixer (4, 4′, 4″″) is drivable from the outside the container (1, 1″″), at least part of the mixer shaft (9, 9′, 9″, 9′″, 9″″) projecting into the container interior is foldable and is designed such that the mixer shaft (9, 9′, 9″, 9′″, 9″″) can be stabilized by flowable media that can be introduced from the outside.

2. A container (1, 1″″) a flexible container wall (2) defining a container interior (3, 3′″), a mixer (4, 4′, 4″″) arranged in the container interior (3, 3′″) a hollow mixer shaft (9, 9′, 9″, 9′″, 9″″) is passed through the container wall (2) and having an inner end connected to the mixer 4, 4″, 4″″) so that the mixer (4, 4′, 4″″) is drivable from-the outside the container (1, 1″″), the mixer (4, 4′, 4′″) being hollow, and foldable and being designed such that the mixer (4, 4′, 4″″) can be stabilized by flowable media that can be introduced from the outside, the mixer shaft (9, 9′, 9″, 9′″, 9″″) and the mixer (4, 4′, 4″″) having cavities connected in a communicating manner.

3. The container as claimed in claim 1, characterized in that the flowable media are gases or curable gels, polymer foams, pastes and resins.

4. The container as claimed in claim 1, characterized in that the mixer shaft (9, 9′, 9′″, 9″″) or the mixer (4, 4′, 4″″) is inflatable.

5. The container as claimed in claim 1, characterized in that the mixer shaft (9, 9′, 9′″, 9″″) has at least one stabilizing chamber (17) that is inflatable from the outside and runs in a longitudinal direction thereof.

6. The container as claimed in claim 5, characterized in that the stabilizing chamber (17′) runs helically in the mixer shaft (9′) toward the mixer (4′).

7. The container as claimed in claim 6, characterized in that the stabilizing chamber (17′) is coiled in a direction opposite to a direction of rotation (20) of the mixer (4′).

8. The container as claimed in claim 1, characterized in that the mixer shaft (9, 9″, 9′″) has at least one stabilizing channel (21, 21′″) that runs in a longitudinal direction thereof, is fittable from the outside and into which a stabilizing rod (22, 22′″) can be introduced.

9. The container as claimed in claim 7, characterized in that the stabilizing channel (21, 21′″) of the mixer shaft (9″, 9′″) runs helically in the mixer shaft (9″, 9′″) toward the mixer (4″, 4′″).

10. The container as claimed in claim 8, characterized in that the stabilizing channel (21, 21′″) is coiled in direction opposite to a direction of rotation of the mixer (4″, 4′″).

11. The container as claimed in claim 9, characterized in that two stabilizing channels (21, 21′″) are coiled in opposing directions and are arranged in the mixer shaft (9″, 9′″).

12. The container as claimed in claim 8, characterized in that the stabilizing rod (22, 22′″) is a metal wire.

13. The container as claimed in claim 5, characterized in that the stabilizing chamber (17, 17′, 17′″, 17″″) is connected to a safety valve (16).

14. The container as claimed in claim 1, characterized in that the mixer shaft (9″″) has, parallel to a longitudinal axis (23) thereof, at least two mutually opposite, parallel guide channels (24) in which two flexible tension wires (25) are guided, said tension wires having inner ends (26) facing the mixer (4″″) and fastened in a region of the inner end of the mixer shaft (9″″) and the tension wires having outer ends facing away from the mixer (4″″) and projecting on the outside of the container (1″″), the tension wires being guided in a sliding manner in the guide channels (24) and being braceable at a drive-side mixer shaft end in order to stabilize the mixer shaft (9″″).

15. The container as claimed in claim 1, characterized in that the mixer shaft (9, 9′, 9″, 9′″, 9″″) is formed from plastic.
